(19) United States
(12) Patent Application Publication
(10) Pub. No.: US 2023/0340649 A1
(43) Pub. Date: Oct. 26, 2023

(54) PREPARATION OF NICKEL-BASED ALLOYS USING WASTE MATERIALS

(71) Applicant: NEWSOUTH INNOVATIONS PTY LIMITED, (US)

(72) Inventors: Samane MAROUFI, Sydney (AU); Veena SAHAJWALLA, Sydney (AU); Rifat FARZANA, Sydney (AU)

(21) Appl. No.: 17/767,587

(22) PCT Filed: Oct. 9, 2020
(86) PCT No.: PCT/AU2020/051087

§ 371 Date: Apr. 8, 2022

(30) Foreign Application Priority Data
Oct. 11, 2019 (AU) 2019903824

(51) Int. Cl. C22C 33/02; B09B 3/40; B09B 3/20; H01M 10/54

(52) U.S. Cl. CPC C22C 33/0235; B09B 3/40; B09B 3/20; H01M 10/54; B09B 2101/16

(57) ABSTRACT

The present invention relates generally to methods for the preparation of nickel-based alloys using waste materials, and more particularly to the preparation of nickel-based alloys using spent batteries.

### FIELD OF THE INVENTION

The present invention relates generally to methods for the preparation of nickel-based alloys using waste materials, and more particularly to the preparation of nickel-based alloys using spent batteries.

### BACKGROUND OF THE INVENTION

Any discussion of the prior art throughout this specification should in no way be considered as an admission that such prior art is widely known or forms part of the common general knowledge in the field.

Many handheld electronic devices and other consumer devices are powered by batteries. Battery consumption is continuing to increase globally and in Australia alone 345 million handheld batteries are consumed annually, and about 264 million reach end-of-life. Less than 6% of these batteries are recycled.

Nickel-metal hydride (Ni-MH) batteries are currently one of the most widely used rechargeable batteries. This type of battery has the advantage of low self-discharge rates, reasonable environmental compatibility, safety and the feasibility to function efficiently within a wide range of temperatures. It is estimated that 200 million waste Ni-MH batteries are discarded annually from which 1965 tons of nickel and 337 tons of cobalt may be recovered every year. Worldwide annual production of nickel is around 2 million tonnes which is mostly used for stainless steel and non-ferrous alloy production. The majority of this nickel is obtained from ores. Recycling/recovering nickel from waste provides an alternative source of nickel that does not rely on ore.

Waste plastic generation continues to increase globally year on year. As the fastest growing waste on the planet, e-waste comprises about 20% plastic.

The present inventors have developed a method for preparing nickel-based alloys from discarded Ni-MH batteries using waste plastics as a reducing agent.

### SUMMARY OF THE INVENTION

In a first aspect, the present invention provides a method of producing a nickel-containing alloy, the method comprising heating a mixture comprising carbon, nickel and an additional metal, wherein the nickel is obtained from a battery.

In some embodiments, the carbon is obtained from a waste material.

In a second aspect the present invention provides a method of producing a nickel-containing alloy, the method comprising heating a mixture comprising carbon, nickel and an additional metal, wherein the carbon is obtained from a waste material.

In some examples, prior to heating, the nickel, the additional metal and the waste material are formed into one or more pellets.

In some examples, the mixture is free, or substantially free, of a carbon source other than the waste material.

In some examples, the waste material is waste plastic.

In some examples, the waste plastic is ground.

In some examples, the waste plastic is e-waste plastic.

In some examples, the e-waste plastic is obtained from computers.

In some examples, the e-waste plastic is obtained from computer monitors.

In some examples, the e-waste plastic is obtained from computer monitor base stands and/or computer monitor outershells.

In some examples, the carbon and the additional metal are obtained from the waste material.

In some examples, the waste material is waste toner.

In some examples, the mixture is free, or substantially free, of coal, coke, carbon char, charcoal and graphite.

In some examples, the heating is performed at a temperature of at least about 1000° C.

In some examples, the heating is performed at a temperature between about 1000° C. and about 1600° C.

In some examples, the heating is performed at a temperature between about 1500° C. and about 1600° C.

In some examples, the heating is performed in an inert atmosphere, such as for example an argon atmosphere.

In some examples, the nickel is in the form of nickel oxide and/or nickel hydroxide.

In some examples, the nickel is obtained from waste batteries.

In some examples, the waste batteries are waste nickel-metal hydride (Ni-MH) batteries.

In some examples, the nickel is obtained from electrodes of waste Ni-MH batteries.

In some examples, the additional metal is one or more of: cobalt, iron, potassium, zinc, lanthanum or cerium-containing compound.

In some examples, the additional metal is in the form of an oxide.

In some examples, the additional metal is cobalt oxide.

In some examples, the additional metal is obtained from waste batteries.

In some examples, the additional metal is obtained from electrodes of waste Ni-MH batteries.

In some examples, the nickel-containing alloy is a Ni—Co alloy.

In some examples, the additional metal is iron.

In some examples, the iron is in the form of iron oxide.

In some examples, the nickel-containing alloy is a Ni—Fe alloy.

In some examples, the heating is performed for a period of time between about 2 minutes and about 90 minutes.

In some examples, the heating is performed for a period of time between about 2 minutes and about 15 minutes.

In some examples, the method is carried out in a horizontal tubular furnace.

In a third aspect, the present disclosure provides a nickel-containing alloy when produced by the method of the first aspect or the second aspect.

In some examples, the nickel-containing alloy comprises more than about 50% nickel.

In some examples, the nickel-containing alloy comprises between about 70% and about 95% nickel.

In some examples, the nickel-containing alloy comprises between about 5% and about 30% cobalt.

In some examples, the nickel-containing alloy comprises more than about 10% iron.

In some examples, the nickel-containing alloy comprises between about 70% and about 90% nickel, and between about 10% and about 30% iron.

In some examples, the nickel-containing alloy comprises between about 85% and about 95% nickel, and between about 5% and about 15% cobalt.

### Definitions

Throughout this specification, unless the context requires otherwise, the word “comprise”, or variations such as “comprises” or “comprising” will be understood to imply the inclusion of a stated element, integer or step, or group of elements, integers or steps, but not the exclusion of any other element, integer or step, or group of elements, integers or steps. Thus, in the context of this specification, the term “comprising” means “including principally, but not necessarily solely”.

In the context of this specification the term “about” is understood to refer to a range of numbers that a person of skill in the art would consider equivalent to the recited value in the context of achieving the same function or result.

In the context of this specification, the term “e-waste plastic” is understood to mean plastic that is part of an electrical or electronic device. Examples include the plastic that surrounds the exterior of computer monitors, keyboards, desk telephones, rear sides of televisions, CD/DVDs, printers, toner cartridges, mobile telephones and the like.

### BRIEF DESCRIPTION OF THE DRAWINGS

Embodiments of the invention will now be described by way of example only with reference to the accompanying drawings, in which:

FIG. 1: A method for preparing nickel-containing alloys from waste Ni-MH batteries and waste plastic in accordance with one embodiment of the invention.

FIG. 2: Schematic of a horizontal tube furnace arrangement that may be used to perform the method.

FIG. 3: (a) Waste Ni-MH batteries, (b) optical micrograph of cross section and (c) component-wise weight percent distribution.

FIG. 4: (a) XRF and (b) XRD, (c) Raman, and (d) FTIR of the feed material (positive electrode) of waste Ni-MH battery.

FIG. 5: FTIR spectra of (a) base plastic and (b) outershell plastic.

FIG. 6: TGA and DTG curves of (a) base plastic and (b) outershell plastic.

FIG. 7: 3D projection of FTIR of the gas evolved from thermal decomposition of (a) base plastic and (b) outershell plastic, and comparison of the gas FTIR spectra at temperatures of 450° C. and 850° C. for (a₁) base plastic and (b₁) outershell plastic.

FIG. 8: (a) Raman and (b) XRD spectra of fine black carbon collected at 15 min.

FIG. 9: Gas evolution spectra (H₂, CO, CH₄, and CO₂) study by IR gas analysis (a) base plastic (b) outershell plastic with a separate plot of gas curves (CO, CH₄ and CO₂) for (a₁) base plastic and (b₁) outershell plastic.

FIG. 10: (a) H₂ release comparison between base plastic and base plastic+positive electrode; (b) CO release comparison between base plastic and base plastic+positive electrode; (c) H₂ release comparison between outershell plastic and outershell plastic+positive electrode; (d) CO release comparison between outershell plastic and outershell plastic+positive electrode.

FIG. 11: % Reduction calculated based on (a) oxygen loss as reported by IR gas analyser (b) total oxygen released over time (0-15 min in the hot zone).

FIG. 12: Calculated % extraction w.r.t time for the obtained product samples.

FIG. 13: XRD patterns of the metallic spectrum obtained at different reduction times using base plastic and outershell plastic as reductants compared with that of reference Ni.

FIG. 14: XRD patterns of the slag spectrum.

FIG. 15: (a) XPS analysis results of the product obtained by using base plastic and outershell plastic and (b) atomic concentration of all elements.

FIG. 16: EDS spectrum showing metal peaks in the product obtained at 8 and 15 min by using both plastics.

FIG. 17: SEM images of the products obtained at 15 min using (a) base plastic, (b) outershell plastic, and at 8 minutes using (c) base plastic (d) outershell plastic.

FIG. 18: ICP-OES result of the product obtained at 6, 8, and 15 minutes using base and outershell plastic.

FIG. 19: SEM-EDS mapping, XPS and XRD analyses of waste Ni-MH battery electrodes.

FIG. 20: (a)-(e) SEM-EDS mapping, (f) TGA with derivative wt %, and (g) XRD spectrum of the waste toner.

FIG. 21: In situ reduction reaction of waste Ni-MH electrodes with waste toner powder at 1550° C. and formation/separation of metal and slag phases.

FIG. 22: Gas evolution comparison (CO and H₂) during reduction reaction of waste Ni-MH electrodes using waste toner powder (75% and 50%).

FIG. 23: XRD spectrum of Fe—Ni alloy.

FIG. 24: (a) SEM, (a1)-(a4) EDS mapping and (c) EDS spectrum of Fe—Ni alloy obtained using 75% waste toner; and (b) SEM, (b1)-(b4) EDS mapping and (c) EDS spectrum of Fe—Ni alloy obtained using 50% waste toner.

FIG. 25: Alloy product showing metal droplets and slag blanket obtained at 1550° C. using (a) 75% waste toner and (b) 50% waste toner.

FIG. 26: EDS mapping of different REOs and EDS spectrum obtained from the slag using (a) 75% and (b) 50% waste toner at 1550° C.

FIG. 27: EPMA (a) image of metal and slag phase, and (b) element distribution and concentration in specified area using 75% toner.

### DETAILED DESCRIPTION

The present invention broadly relates to a method for preparing a nickel-containing alloy, the method comprising heating a mixture comprising waste material, nickel and an additional metal.

In some embodiments the nickel and the additional metal may be obtained from waste batteries, such as for example waste Ni-MH batteries. However, those skilled in the art will appreciate that the nickel and the additional metal may also be obtained from other waste sources, such as for example, ferrite, NiCd batteries and electrochromic devices.

The present disclosure also provides a method of producing a nickel-containing alloy, the method comprising heating a mixture comprising carbon, nickel and an additional metal, wherein the nickel is obtained from a battery.

In some embodiments, the additional metal and the carbon may be obtained from the waste material. For example, the additional metal and the carbon may be obtained from waste toner. The waste toner may comprise carbon in the form of a resin and iron in the form of iron oxide.

In some embodiments the nickel is nickel oxide and/or nickel hydroxide. In some embodiments the additional metal is one or more of cobalt, iron, potassium, zinc, lanthanum, silicon, aluminium, manganese, zinc, calcium, neodymium or a cerium-containing compound. In one embodiment the additional metal may be an oxide.

Both the positive and negative electrodes of Ni-MH batteries are sources of nickel in the form of nickel oxide and nickel hydroxide. For example, the positive electrode of Ni-MH batteries may contain as much 65% by weight of nickel oxide. The positive electrode of Ni-MH batteries may also be a source of additional metals, such as for example cobalt, potassium, zinc, lanthanum and/or cerium oxides.

In some embodiments heating may be performed at a temperature of at least about 1000° C. In other embodiments, heating may be performed at a temperature between about 1000° C. and about 2000° C., or at a temperature between about 1000° C. and about 1900° C., or at a temperature between about 1000° C. and about 1800° C., or at a temperature between about 1000° C. and about 1700° C., or at a temperature between about 1000° C. and about 1600° C. In one embodiment, heating may be performed at a temperature between about 1500° C. and about 1600° C.

Heating may be performed in an inert atmosphere, such as for example an argon atmosphere, a nitrogen atmosphere or an atmosphere of another inert gas.

Heating may be performed for a period of time between about 2 minutes and about 30 minutes, or for a period of time between about 2 minutes and about 15 minutes, or for a period of time between about 2 minutes and about 10 minutes. The inventors have found that >90% reduction of nickel oxide can be achieved in as little as 8 minutes.

In some embodiments, heating is performed for a period of between about 2 minutes and about 90 minutes, such as between about 15 minutes and about 75 minutes or between about 30 minutes and 60 minutes. As described herein, heating at a mixture comprising waste toner and electrodes from Ni-MH batteries at a temperature of between about 1500° C. and about 1600° C. for a period of about 60 minutes produces a Ni—Fe alloy.

Waste plastic suitable for use in the method of the invention includes, for example, waste plastic products comprising one or more of: polyethylene terepthalate (PET), polyethylene (PE), polypropylene (PP), polystyrene (PS), polycarbonate (PC) and/or polmethylmethacrylate (PMMA). Additional plastics that may be used will be familiar to those skilled in the art. Certain additional plastics may include polymer blend and fire/flame retardant additives.

In some embodiments, the waste plastic is e-waste plastic. E-waste typically comprises about 20% plastic. In one embodiment the e-waste plastic is obtained from computer monitors, such as computer monitor base stands (also referred to herein as “base plastic”) and plastic that surrounds the exterior of the monitors (also referred to herein as “outershell plastic”). Monitor base stand plastic typically comprises acrylonitrile butadiene styrene (ABS) and PMMA. Outershell plastic typically comprises PS, PC and ABS-flame retardant.

Waste toner may also provide a suitable carbon source in the form of a resin.

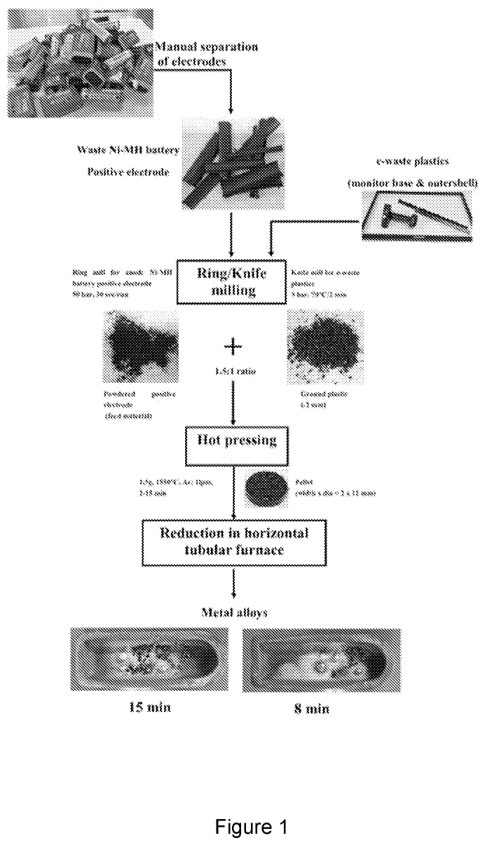

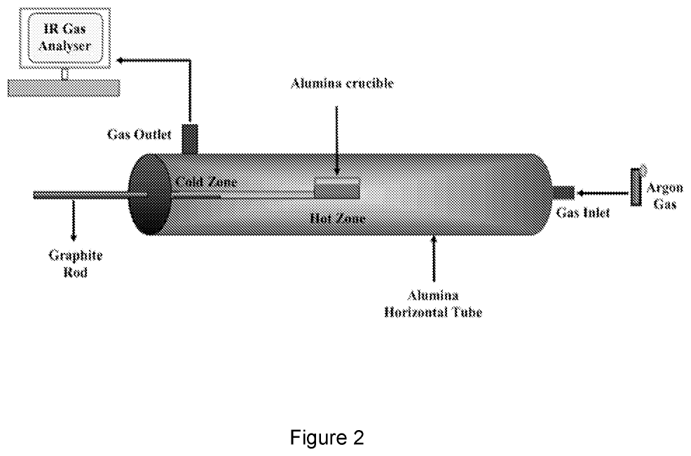

FIG. 1 depicts a method for preparing nickel-containing alloys from waste Ni-MH batteries and waste plastic in accordance with one embodiment of the invention. In this embodiment, the positive electrodes of waste Ni-MH batteries are separated and milled to form a powder. Computer monitor base stands and plastic that surrounds the exterior of computer monitors are ground to a size of approximately 2 mm. The powdered positive electrodes and ground plastic are then mixed in a ratio of about 1.5:1 and hot pressed to provide pellets having approximate dimensions of 2 mm×12 mm (width×diameter). The pellets are then subjected to thermal reduction in the horizontal furnace arrangement depicted in FIG. 2.

In the method described, the waste material (eg, waste plastic or waste toner) functions as a reducing agent by providing a source of carbon. As such, the mixture may be free, or substantially free, of a carbon source other than the waste material. In another embodiment the mixture may be free, or substantially free, of coal, coke, carbon char, charcoal and graphite.

In one embodiment the present invention provides a method of producing a nickel-cobalt alloy, the method comprising heating a mixture comprising e-waste plastic, a nickel-containing compound and a cobalt-containing compound, wherein the nickel-containing compound and cobalt-containing compound are obtained from waste Ni-MH batteries.

In another embodiment the present invention provides a method of producing a nickel-cobalt alloy, the method comprising heating a mixture comprising e-waste plastic, a nickel-containing compound and a cobalt-containing compound, wherein the nickel-containing compound and cobalt-containing compound are obtained from positive electrodes of waste Ni-MH batteries.

In a further embodiment the present invention provides a method of producing a nickel-cobalt alloy, the method comprising heating a mixture comprising e-waste plastic, a nickel-containing compound and a cobalt-containing compound, wherein the nickel-containing compound and the cobalt-containing compound are obtained from positive electrodes of waste Ni-MH batteries, and wherein the mixture is provided in the form of pellets.

In yet another embodiment the present invention provides a method of producing a nickel-cobalt alloy, the method comprising:
forming a mixture comprising (i) positive electrodes obtained from waste Ni-MH batteries, and (ii) ground e-waste plastic; and
heating the mixture at a temperature between about 1000° C. and about 1600° C. so as to obtain the nickel-cobalt alloy.

In yet another embodiment the present invention provides a method of producing a nickel-cobalt alloy, the method comprising:
forming a mixture comprising (i) powdered positive electrodes obtained from waste Ni-MH batteries, and (ii) ground e-waste plastic;
converting the mixture to one or more pellets; and
heating the pellets at a temperature between about 1000° C. and about 1600° C. so as to obtain the nickel-cobalt alloy.

In still a further embodiment the present invention provides a method of producing a nickel-cobalt alloy, the method comprising:
forming a mixture comprising (i) powdered positive electrodes obtained from waste Ni-MH batteries, and (ii) ground e-waste plastic;
converting the mixture to one or more pellets; and
heating the pellets at a temperature between about 1000° C. and about 1600° C. so as to obtain the nickel-cobalt alloy,
   wherein the e-waste plastic is obtained from computer monitors.

In another embodiment, the present disclosure provides a method of producing a nickel-iron alloy, the method comprising heating a mixture comprising waste toner and electrodes obtained from waste Ni-MH batteries so as to produce the nickel-iron alloy.

In another embodiment, the present disclosure provides a method of producing a nickel-iron alloy, the method comprising heating a mixture comprising waste toner and electrodes obtained from waste Ni-MH batteries at a temperature of between about 1500° C. and about 1600° C. for a period of between about 15 minutes and 70 minutes so as to produce the nickel-iron alloy.

In another embodiment, the present disclosure provides a method of producing a nickel-iron alloy, the method comprising:
forming a mixture comprising (i) electrodes obtained from waste Ni-MH batteries, and (ii) waste toner;
converting the mixture to one or more pellets; and
heating the one or more pellets at a temperature of between about 1500° C. and about 1600° C. for a period of between about 15 minutes and 90 minutes so as to produce the nickel-iron alloy.

Embodiments of the methods described herein provide efficient and cost-effective routes to prepare nickel-based alloys using two waste streams, i.e., waste batteries and waste another waste material such as waste plastic or waste toner. The methods have the potential to ease reliance on mining sources of nickel and other metals, whilst at the same time contributing to the reduction of the ever-growing waste stream.

### Example 1

### Materials and Method

Discarded Ni-MH batteries and waste plastics (base and outershell) were collected from the UNSW recycling site and the Reverse E-waste, Sydney, Australia. After dismantling the waste batteries manually, positive and negative electrodes were identified and separated before grinding to powder form using a Rocklabs Ring Mill at 90 bar for 30 sec per run. Likewise, the waste plastics were cut into small parts manually before crushing into fine size (about 2 mm) with the help of a knife mill. The positive electrode (rich in NiO) of waste Ni-MH batteries was selected as the feed material. Stoichiometric mixture of carbon required to reduce nickel oxide was determined by NiO+C=Ni+CO reaction, however an excess amount of carbonaceous materials was considered for the present study. The elemental composition of the positive electrode and plastics was determined and a stoichiometric mixture of waste plastics and positive electrode was prepared in 1:1.5 ratio in 1.5 g scale before hot-pressing to form pellets through a uniaxial hydraulic press operated at 3 bar, 70° C. for 2 minutes.

Pellets were placed in a ceramic crucible covered with a lid (so as to maximise the usage of generated gases from the plastic) and kept on the sample holder before inserting into a horizontal tube furnace (100 cm length×5 cm diameter), the schematic of which is illustrated in FIG. 2. The sample was initially held at the cold zone of the furnace for 8 minutes before insertion into the hot zone to avoid any possibility of thermal shock. An argon gas flow rate of 1 litre per minute was maintained throughout the experiment. Before performing the reduction experiments, the thermal degradation behaviour of both types of waste plastics was studied in detail by exposing it to 1550° C. for different time periods. After every experiment, including the reduction, the samples were moved from the hot to cold zone and allowed to cool for 10 minutes. Whilst maintaining a constant temperature of 1550° C., time was varied (2 minutes, 4 minutes, 6 minutes, 8 minutes and 15 minutes) for nickel oxide reduction studies. Real-time gas generation was monitored with an infrared gas analyser (IR, ABB, Advanced Optima Series, AO2020). The product obtained was characterised by inductive coupled plasma optical emission spectroscopy (ICP-OES), X-ray photoelectron spectroscopy (XPS), X-ray powder diffraction (XRD), field emission scanning electron microscopy (FE-SEM) and energy dispersive X-ray spectroscopy (EDS).

### Characterisation Method

The cross-section of the waste Ni-MH batteries was studied under a Leica Stereo microscope which offered a magnified view of the internal components, interface and external shell. Different elements present in the waste batteries were calculated through inductive coupled plasma mass spectroscopy (ICP-MS) analysis using a PerkinElmer Quadrapole Nexion instrument. For product samples, the ICP-OES technique was adopted.

XRD analysis, using PANalytical X'Pert Pro multipurpose X-ray diffractometer, was applied to identify different phases of the feed material and the alloy product. The solid-state analysis was performed in Empyrean II choosing the prefix module BRAG-Brentano^{HD} (incident beam) and PiXcel 1D, 7.5 mm fixed anti-scatter slit (diffracted beam). Employing the analysis parameters 45 kV tension, 40 mA current, 1-degree anti-scatter fixed slit with 0.016726 scan speed and 400 sec/step and ½ degree divergence slit, various diffraction patterns were generated. XPS analysis of the etched product surface (300 s) was performed at a spot size of 500 μm with mono-chromated Ai K alpha (energy 1486.68 eV) for elemental survey. Elemental analysis was performed, using PANalytical PW2400 Sequential Wavelength Dispersive X-ray fluorescence spectrometry (WDXRF). For the waste plastics, the percentage of carbon, hydrogen, nitrogen and sulfur was determined. The surface chemistry of the feed was analyzed with the help of absorption spectra obtained via Fourier Transform Infrared Spectroscopy (FTIR) in the wavenumber region 4000-500 cm⁻¹ using a Spectrum 100, PerkinElmer FTIR spectrometer. Laser Raman spectroscopy (Renishaw inVia) was obtained for the feed material at room temperature for detecting metal oxides. SEM, using Hitachi 3400-I, was performed on the product samples for surface morphology investigation with EDS (Bruker X flash 5010) that revealed the distribution of elements present on the product's surface.

### Results and Discussion

A conceptual flowsheet of the recycling technique is presented in FIG. 1.

### Characterisation of the Positive Electrode

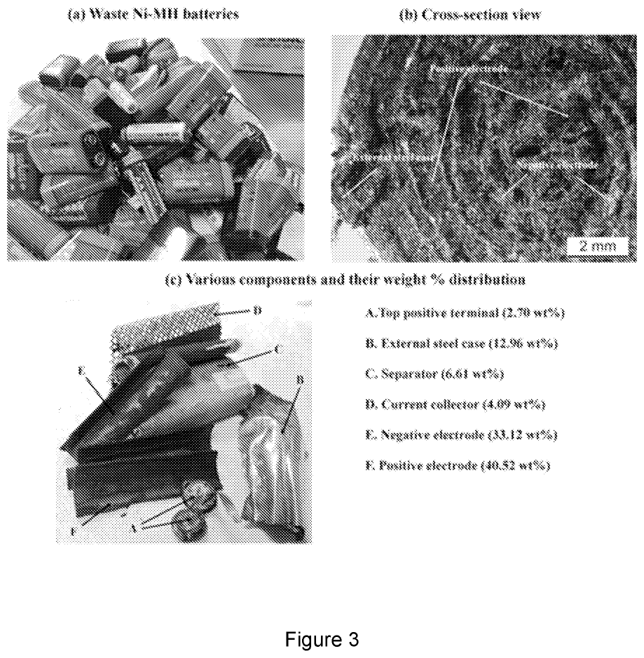

Waste Ni-MH batteries used in this example are shown in FIGS. 3(a)-(c). Both positive and negative electrode layers are visible from the cross-sectional micrograph occurring spirally and alternately in the cylindrical battery unit. The positive electrode component, as seen in the form of bands with 40.52 wt %, was separated and used in the method.

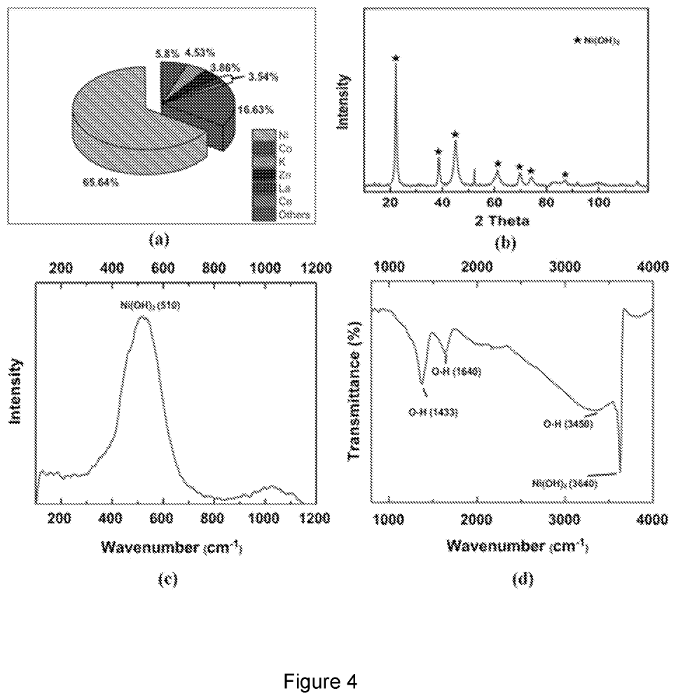

The characterisation results of positive electrode material of Ni-MH batteries by XRF, XRD, Raman, and FTIR are illustrated in FIG. 4. XRF analysis (FIG. 4a) showed that nickel oxide is the dominant compound (65.64%) along with minor concentrations of Co, K, Zn oxides, and others. The XRD spectrum also confirms the presence of nickel hydroxide (ICDD:04-013-3641) as the dominant phase (FIG. 4(b)). A 20 value ˜22.4° (the longest peak, which corresponds to nickel hydroxide) is observed which belongs to the Brucite group of minerals. Additional peaks occurring at 20 values, ˜38°-˜90° confirm nickel hydroxide as the dominant phase in the positive electrode. The Raman spectra results of FIG. 4(c) show a peak at 510 cm⁻¹, corresponding to nickel hydroxide which also indicates the presence of Ni(OH)₂. FTIR analysis in FIG. 4(d) demonstrates v(OH) stretching, displaying a steep characteristic band at 3640 cm⁻¹ which is due to the nickel hydroxide phase present in the feed material. Additionally, a broad peak can be seen at 3450 cm⁻¹ that corresponds to stretching vibration of O—H atoms present in potassium hydroxide electrolyte. Two parallel peaks observed at 1640 cm⁻¹ and 1433 cm⁻¹ are due to the bending vibration feature of hydroxides.

Characterisation of raw e-waste plastics

E-waste plastics (base and outershell plastic) were subjected to various characterisation studies to determine their role as a potential alternative to traditional carbon sources (such as coal and coke). The carbon content of both plastics was found to be similar, base plastic showing 84.67% carbon and outershell plastic 83.97% carbon, as analysed by a LECO carbon analyser (LECO CS-444). Determination of nitrogen, sulfur and hydrogen percentages was performed by Elemental Combustion Analyser (CHNS) with the help of ElementarvarioMACRO cube in which percentage measurement of hydrogen was carried out through the infrared absorption route in which the gases released from the plastic were passed via heated copper oxide for the conversion of hydrogen gases to water vapour. The gases enter through the IR module and travel via the H₂O detector which then measures the total hydrogen content in the sample. Table 1 highlights the nitrogen and sulfur content along with the percentage of ash generated by combusting both plastics at 800° C. for 1 h. Percentages of nitrogen and sulfur were also found to be similar for both plastics and the ash percentage in outershell plastic was higher overall, however the amount of ash in both plastics was negligible.

TABLE 1
Composition of base and outershell plastics

| Plastic category | C % | H % | N % | S % | Ash % |
|---|---|---|---|---|---|
| Base plastic | 84.67 | 8.44% | 5.52 | 0.09 | 0.04 |
| Outershell plastic | 83.97 | 7.77% | 5.69 | 0.08 | 0.48 |

### Study of Decomposition Behaviour at Low Temperature

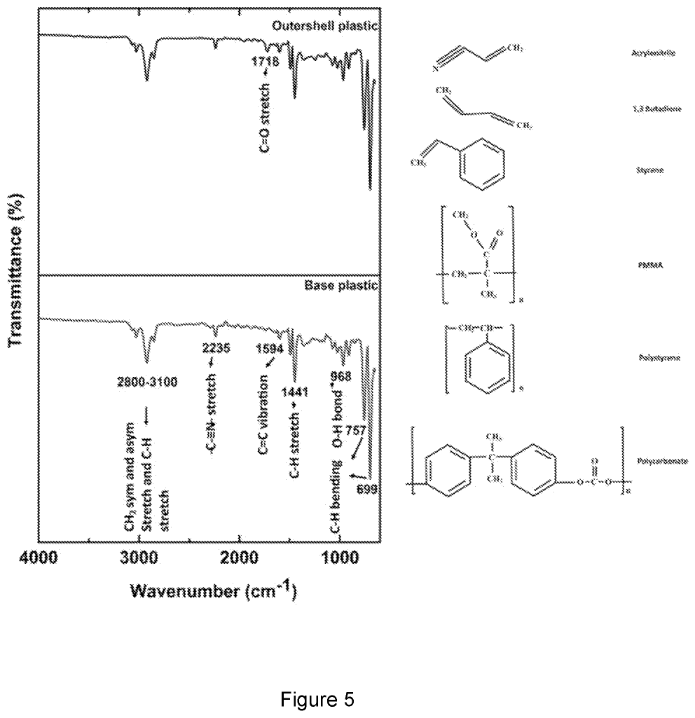

In order to understand the dissociation behaviour of raw polymers present in e-waste plastics at low temperature and the different functional groups associated, characterisation studies and analyses were adopted. FIG. 5 illustrates the FTIR measurement results of both plastics. Bands of the IR spectra exhibit the same functional groups except for the sharp appearance of signals for carboxyl group C═O at 1718 cm⁻¹ for outershell plastic. Characteristic peaks within 2800-3100 cm⁻¹ are due to the CH₂ symmetric and asymmetric stretching and C—H stretch around 3026 cm⁻¹ from all polymers. The band at about 1441 cm⁻¹ may be attributed to the bending vibration caused by C—H bonds of the CH₃ group present in PMMA and ABS. Characteristic peaks at about 1594 cm⁻¹ may be attributed to the aromatic C═C vibrations from ABS, PS and PC. Furthermore, the aromatic ring bending vibration and C—H bending mode of the ring occurring outside the plane are seen at 699 cm⁻¹ and 757 cm⁻¹ respectively in both plastics. The presence of a characteristic peak at 2235 cm⁻¹ represents the nitrile functional group in these types of waste plastics that agrees with ABS as part of the composition.

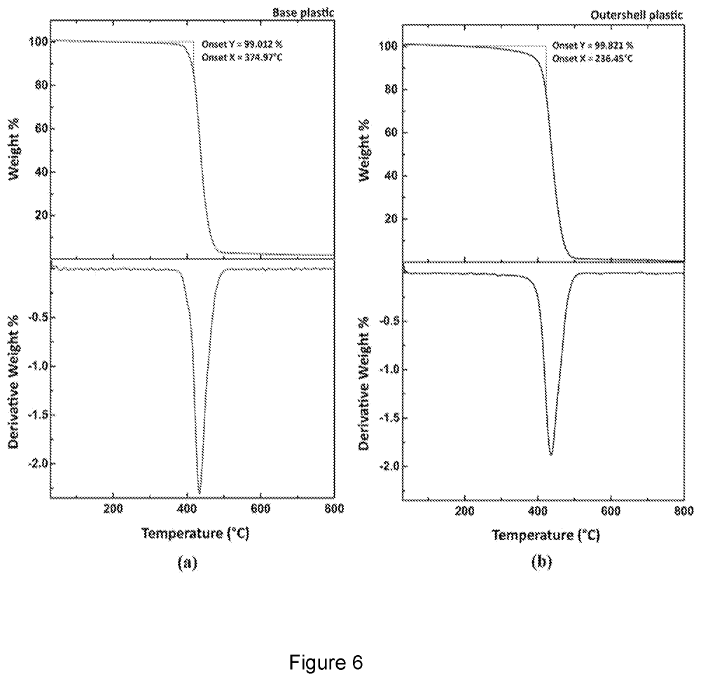

To understand the thermal decomposition of both plastics, thermogravimetric analysis (TGA) was performed at a constant heating rate of 20° C./min from room temperature to˜850° C. under a nitrogen atmosphere. FIG. 6 shows the obtained TGA and the corresponding derivative (DTG) curves for both plastics. Degradation commences at 375° C. for base plastic which is almost 150° C. higher than that of outershell plastic (˜236° C.), indicating some thermal stability. However, the percentage of mass loss at which the degradation begins for both plastics is the same (˜1%) and the DTG curves show a sharp degradation peak occurring at
435° C. for base and outershell plastics. A single step decomposition was observed for both plastics, attaining almost zero wt % at ˜ 480° C. agrees with the ash % analysis of both samples as presented in Table 1. Complete weight loss also proves that the plastics will generate mainly gases due to thermal decomposition.

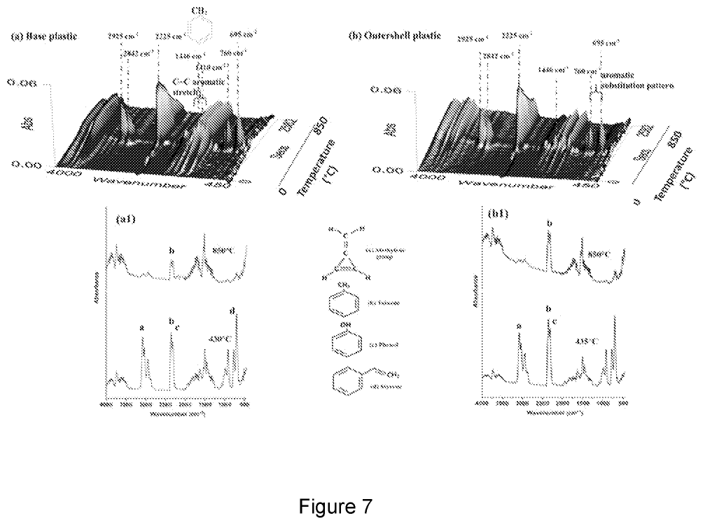

FTIR analysis of the gases released during TGA of waste plastics was also studied as shown in FIGS. 7 (a) and (b). Both plastics showed a similar pattern with the highest peaks occurring in 1283 sec (˜430° C.) for base plastic and 1304 sec (˜435° C.) for outershell plastic, which is in agreement with TGA weight loss. Both asymmetric and symmetric vibrations due to stretching of methylene groups —CH₂ are seen at 2925 and 2842 cm⁻¹ respectively. The overtone band shown at 2225 cm⁻¹ represents the CO stretch as a result of transition of molecules from ground state to excited state. Carbon-carbon stretching then occurs in the aromatic rings (1601 cm⁻¹; 1498 cm⁻¹; 1446 cm⁻¹; 1410 cm⁻¹). However, this stretching is observed to a lesser extent in the outershell plastic (3D pattern) when compared with the base plastic. The out-of-plane C—H bending bands (which are characteristic of the aromatic substitution pattern) are clearly visible clearly at 760 and 695 cm⁻¹ respectively, which were also observed in the solid FTIR spectra of waste plastics (see FIG. 5). It is noted that e-waste plastic contains more single-bonded compounds, which present as feasible reducing agents.

A comparison of the presence of different functional groups at temperatures of 430° C. and 850° C. was made as shown in FIG. 7 (a1) and (b1). The methylene group ceases to occur as the temperature elevates from 430° C. to 850° C. The same behaviour is exhibited by both plastics, however toluene is present in the case of the outershell plastic as the temperature reaches 850° C. Also, the occurrence of styrene at 760 and 695 cm⁻¹ vanishes at higher temperature. Furthermore, the presence of methylene, styrene and phenol confirms the nature of the e-waste plastics as per the composition. In addition to carbon monoxide, additional hazardous gases, such as sulfur dioxide and dioxin, may also be produced. However, treating e-waste plastics at 1550° C. prevents generation of these toxic gases.

### Study of Decomposition Behaviour at High Temperature

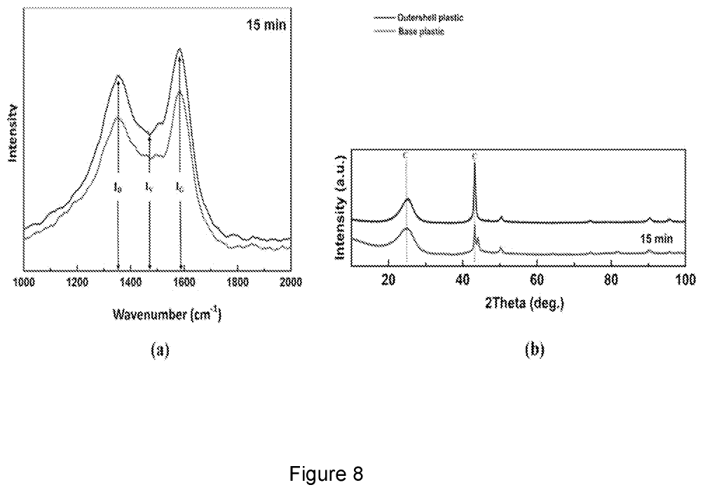

During thermal transformation, both base and outershell plastics did not leave any residue/ash, but rather generated fine black carbon (that flies and sits on the mouth of furnace). FIGS. 8 (a) and (b) show the Raman analysis and XRD spectra of the fine black carbon that was collected after plastics were treated at 1550° C. It is observed that the fine black carbon which forms immediately within 30 seconds comprises a “D” band (˜1350 cm⁻¹) and a “G” band (1580 cm⁻¹). D and G bands represent the disordered and graphitic carbon structures respectively in the fine black. Hence, the intensity ratio, I_{D}/I_{G} (here, I_{G} and I_{D} are G band and D band intensities and Iᵥ is the intensity of the valley between G and D bands) is an indication of the presence of disordered or graphitic carbon in the structures. It was found that this I_{D}/I_{G} ratio for base plastic fine carbon and outershell plastic fine carbon was 0.85 and 0.88 respectively, which indicates the amorphous nature of carbon in outershell and base plastic. However, as the ratio is less than one, and having regard to FIG. 8(a), it is concluded that the amount of graphitic (crystalline) carbon in both plastic types is greater than the disordered carbon.

XRD patterns were also studied for the fine black carbon collected at 15 minutes which also revealed the presence of graphitic carbon in both plastics at 2θ˜26°. The amorphous nature of carbon, due to the presence of γ band, is also observed at 15 minutes for base plastic with two parallel carbon layers present at (200) and (101), having a 2θ value ˜42°

### Study of Gas Evolution at Low and High Temperature

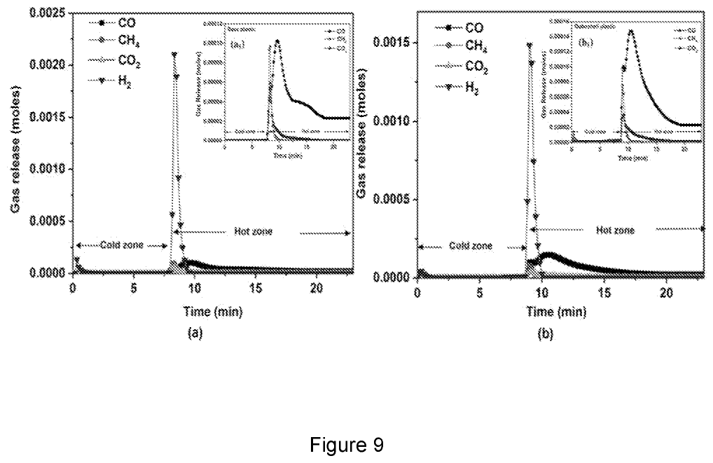

The study of gas evolution at 1550° C. is shown in FIG. 9 covering the gas release occurring in both the cold zone and the hot zone. Both plastics released the highest amount of H₂ gas and a moderate amount of CO, CO₂ and CH₄ gasses. All these gasses helped to create a reducing environment to reduce NiO via gas phase reduction. It was observed that due to low thermal stability, the outershell plastic started to release a small amount of gasses in the cold zone where the temperature was ˜300° C. While pushing towards the hot zone (1550° C.), gases were released, and within 3 minutes reached almost zero. The constant release of CO may be a result of the chemical reactions occurring inside the furnace. FIGS. 9 (a1) and (b2) show the evolution of CO, CH₄, and CO₂ from base plastic and outershell plastic respectively. When the three gas release curves are plotted together with the amount of H₂ released from both plastics, as shown in FIG. 9 (a) and (b), it is observed that the release of hydrogen from both plastics is not only quick but also high in volume as compared to CO, CO₂ and CH₄. Therefore, even if hydrogen remains in the system for an initial 2 minutes in the hot zone (1550° C.), predicting its contribution in the reduction process is high, owing to its high volume and high reactivity at such a temperature.

Reduction of NiO by e-Waste Plastic

Reduction of NiO occurs predominantly by reducing gases emanating from the e-waste plastics following decomposition. It was observed that reduction of NiO by waste plastic was dominated by gas phase reduction due to the generation of reducing gases (CO, CO₂, H₂, CH₄), with a negligible amount of ash.

The expected primary reactions taking place to reduce NiO are summarised below in Reactions 1 to 4:

Ni(OH)₂(s)→NiO(s)+H₂O(g)ΔG_{1550° C.}=−194kJ/mol Reaction 1

NiO(s)+CH₄(g)→Ni(l/s)+CO(g)+2H₂(g)ΔG_{1550° C.}=−302kJ/mol Reaction 2

NiO(s)+H₂(g)→Ni(l/s)+H₂O(g)ΔG_{1550° C.}=−68kJ/mol Reaction 3

NiO(s)+CO(g)→Ni(l/s)+CO₂(g)ΔG_{1550° C.}=−47kJ/mol Reaction 4

The exothermic Boudouard reaction (Reaction 5) also accompanies the above reduction reactions to evolve CO in the system.

CO₂(g)+C(s)→2CO(g)ΔG_{1550° C.}=−146kJ/mol Reaction 5

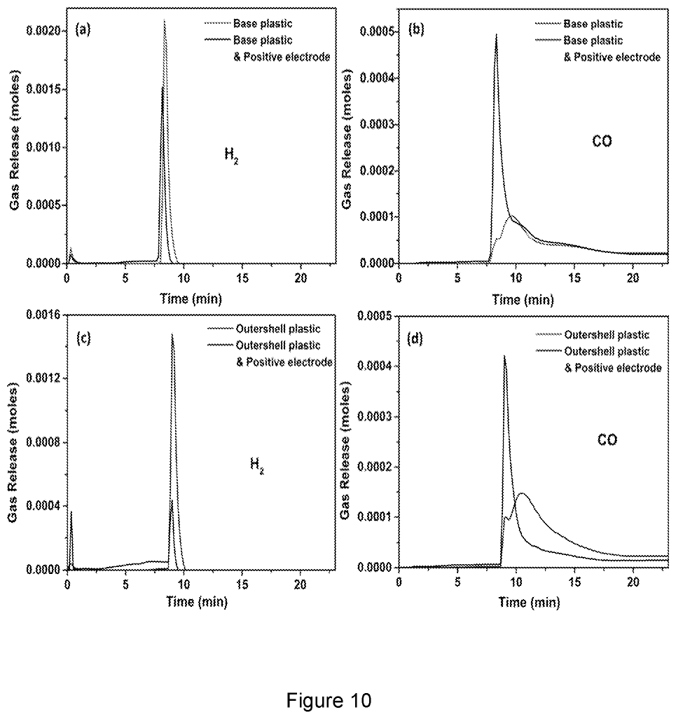

Nickel hydroxide present in the positive electrode of Ni-MH batteries will thermally decompose to NiO within the cold zone temperature (˜300° C.) (reaction 1). Reduction of NiO by methane is also spontaneous within the temperature range (cold zone to hot zone) and produced H₂ and CO off-gases from the reduction reaction (reaction 2). Hydrogen participated in the reduction process due to its dynamic and reactive properties at high temperatures (reaction 3). A comparative graph (FIG. 10 (a) & (c)) showed that the amount of H₂ generated from waste plastic alone is higher than the pellet (waste plastic+electrode) which demonstrates that a fraction of generated H₂ participated in the reduction reactions. Also, the amount of H₂ generated from base plastic (1.07×10⁻³ moles-min (gas generated in moles at a specified time) as calculated area under the peak curve) alone is higher than that of outershell plastic (0.79×10⁻³ moles-min (gas generated in moles at a specified time) as calculated under the peak curve) which accords with the percentage of hydrogen determined by CHNS analyser. However, the release of hydrogen in the hot zone quickly attains a sharp peak and is short lived (˜2 min), thus indicating that its participation in reduction is only for an initial few minutes. This release trend of hydrogen and drop in the gas profile within a few minutes of exposure in the hot zone during reduction matches that of waste plastics considered alone in FIG. 9 (a) and (b).

CO, which is the major off-gas for the reduction of NiO, showed a sharp increase within three minutes in the hot zone and can be attributed to the reduction reaction depicted in reaction 2. CO generation during the reduction reactions can also be attributed to the Boudouard reaction (reaction 5). It is seen from FIGS. 10 (b) and (d) that the volume of CO using both plastics does not attain zero, and there is still some release happening which indicates progress of the reduction reaction.

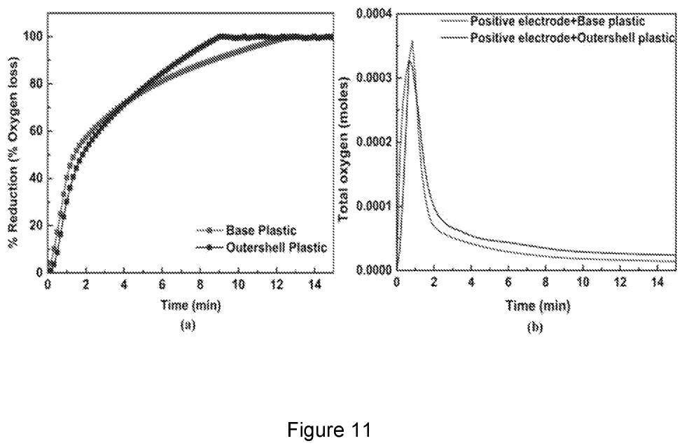

Overall reduction percentage was measured (as shown in FIG. 11 (a)) using the weight loss by quantifying off gas (total oxygen coming from CO and CO₂), following IR as a function of time (Equation 1). Reduction reactions that occurred when the pellet was placed in the zone were considered for this reduction percentage calculation based on oxygen loss. However, the loss of oxygen which combines with hydrogen to produce water vapour was not considered during this reduction percentage calculation. A higher slope of the reduction extent curve for base plastic may be attributed to the higher amount of generated gas for NiO reduction. It is observed that when the reaction reaches the 8 minute mark, reduction appears to be more than 90% complete.

This inference is apparent when referring to FIG. 11 (b), which reports about the total volume of oxygen (in moles) released over time (0 to 15 minutes) when reduction was carried out using base and outershell plastics in the hot zone. The oxygen release profile had started dropping right past 2 minutes and attains linearity after 8 minutes of reduction.

The reduction percentage calculation was performed by weighing the product metal samples and slag obtained. It was noted that as the feed material was subjected to reduction, right from the time it was placed in the cold zone to completion of reduction in the hot zone, the resultant product obtained is as a result of all gases (H₂, CO, CH₄ and CO₂) participating in the reduction. Initially, the estimated amount of metals (nickel and cobalt: W, =0.51 g)) present in the treated positive electrode (0.9 g) was calculated using ICP-OES results, taking an average of 3 analyses. With the approximate weight percentage of metals present as calculated by ICP-OES, and also by weighing the actual metal droplets recovered, there is a possibility of errors in the weighed values. Post reduction, the metal droplets were separated from the slag and weighed for varying reduction times. Due to the absence of metallic droplets in the initial 2 minutes of the reaction in the furnace, the product is not considered for the mass balance. An average of 3 product metal weights (Wₜ) was considered before calculating the % recovery, using the equation given below. The weight of metal (in and out) before and after reduction is shown in Tables 2 (a) and (b) with reduction % calculation. Comparing the reduction percentage in FIG. 11(a), the calculated percentage recovery achieved at 4 and 6 minutes varies (60-70% reduction achieved by calculating the loss of oxygen carried by CO and CO₂ whereas >80% reduction achieved by considering the additional reduction due to H₂ along with CO and CO₂) due to the fact that reduction taking place as a consequence of hydrogen not being considered while arriving at the reduction percentage through oxygen loss. However, when the reduction reaches 8-10 minutes, it appears to be in agreement with the results in FIG. 11 where outershell plastic shows a higher percentage reduction (˜97%) compared to base plastic (˜93%) which is in alignment with the reduction percentage values obtained at 8 minutes as in Table 2 (a) and (b) (outershell plastic shows 96.1% reduction whereas base plastic shows 94.1% reduction).

% Reduction/% Recovery=[(Wᵢ−W_{f}) or Wₜ/Wᵢ]×100 Equation 1

wherein:
Wᵢ=Initial weight of oxygen/metal present in positive electrode
W_{f}=Final weight of oxygen at time t after reduction
Wₜ=Final weight of metal weighed at time t after reduction

TABLE 2
Weight of metal present before and after reduction with % reduction
calculation (a) using base plastic (b) using outershell plastic
(a) Initial weight of metal present
in the positive electrode
(Wᵢ) = 0.51 g; ND = not determined

| | Metal | Metal | Metal | Metal | % Reduction |
|---|---|---|---|---|---|
| Time | (g) | (g) | (g) | (g) | [(Wᵢ-W_{f}) or Wₜ/Wᵢ] × 100 |
| (min) | Wₜ. 1 | Wₜ. 2 | Wₜ. 3 | Wₜ. avg. | Using base plastic |
| 2 | ND | ND | ND | ND | ND |
| 4 | 0.43 | 0.45 | 0.46 | 0.45 | 88.2 |
| 6 | 0.46 | 0.45 | 0.5 | 0.47 | 92.2 |
| 8 | 0.47 | 0.47 | 0.5 | 0.48 | 94.1 |
| 15 | 0.49 | 0.5 | 0.5 | 0.5 | 98 |

(b) Initial weight of metal present in the
positive electrode
(Wᵢ) = 0.51 g; ND = not determined

| | Metal | Metal | Metal | Metal | % Reduction |
|---|---|---|---|---|---|
| Time | (g) | (6) | (g) | (g) | [(Wᵢ-W_{f}) or Wₜ/Wᵢ] × 100 |
| (min) | Wₜ. 1 | Wₜ. 2 | Wₜ. 3 | Wₜ. avg. | Using outershell plastic |
| 2 | ND | ND | ND | ND | ND |
| 4 | 0.41 | 0.42 | 0.4 | 0.41 | 80.4 |
| 6 | 0.43 | 0.41 | 0.45 | 0.43 | 84.3 |
| 8 | 0.49 | 0.47 | 0.5 | 0.49 | 96.1 |
| 15 | 0.5 | 0.49 | 0.49 | 0.49 | 96.1 |

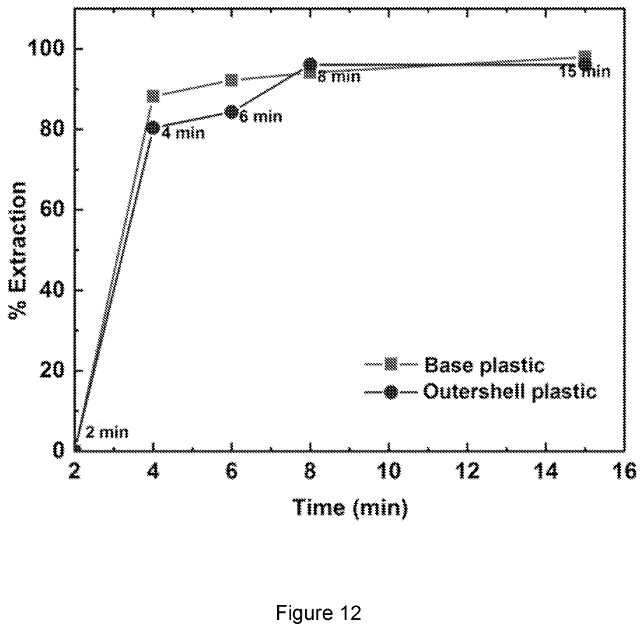

The percentage extraction plot using both plastics as a reductant and all gases contributing to the recovery of metal alloy is illustrated in FIG. 12. The calculated % recovery of metal achieved in 8 minute and 15 minute reduction times is almost the same for both plastics, thereby highlighting that reduction nears completion in 8 minutes.

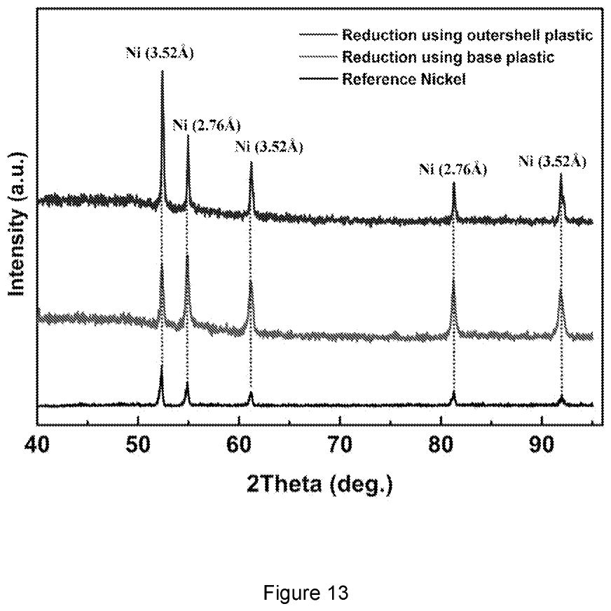

XRD analysis of the product phase obtained using base and outershell plastic wherein the reaction time is 15 minutes is illustrated in FIG. 13. Nickel is found to be widely distributed with two variants existing at different lattice parameters of 3.52 and 2.76. Both products exhibit peaks present at 2θ values ˜52°, 54° 61°, 81°, 91° on orientation planes (111), (110), (200), (220). An XRD analysis was performed on pure nickel (sourced from Shanghai Tankii Alloy (Tankii alloy) as the reference, and the spectrum was matched with that of the product phases. The presence of cobalt was not detected by XRD, possibly owing to its low percentage in the product alloy.

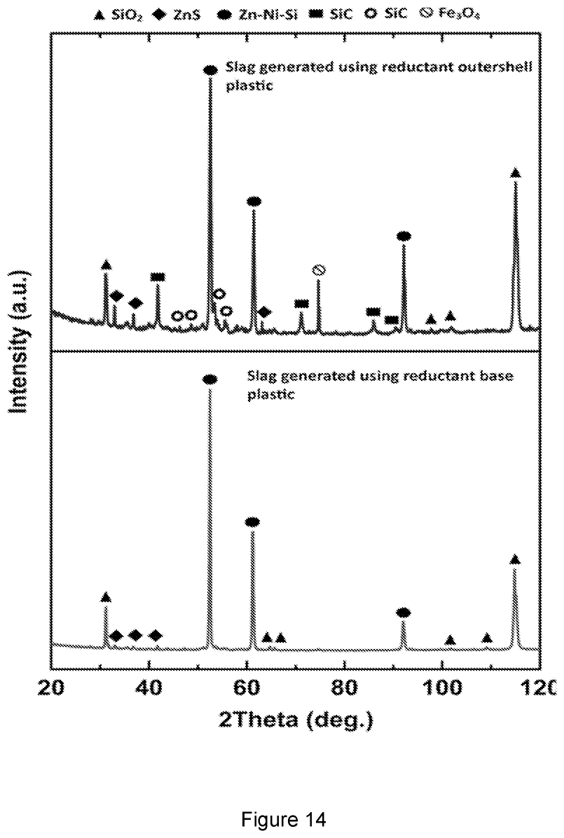

FIG. 14 presents the XRD spectra of the slag phase obtained after 15 minute reduction of feed material with base plastic and outershell plastic. Silicon oxide (SiO₂) with hexagonal crystal system (ICDD:04-008-4821) occurs in (011) and (132) planes at 2θ values 31° and 112° respectively. Other supporting SiO₂ peaks are found at different planes for both plastics. At 2θ values 52°, 61°, and 91°, a compound containing nickel, silicon, and zinc occurs in (112), (200), and (204) planes respectively. Zinc, present in the feed material, appears to have taken some nickel with it and combined itself with silicon to form this tetragonal compound. There are also peaks dedicated to ZnS (ICDD:01-072-9271) seen at 2θ values 33° and 38° in both slags. Sulfur from the waste plastic and zinc vapour from the feed material may have combined to form zinc sulfide which has a high melting point (1850° C.). However, slag obtained using outershell plastic shows SiC (ICDD:04-008-4949) in cubic crystal system at (111) and 2θ value 41°. One peak is also attributed to low magnetite (orthorhombic crystal system), occurring at a 2θ value 74°. This could be explained due to traces of iron seen in the feed material as reported by ICP-MS, which was subjected to oxidation-coprecipitation to attain the orthorhombic structure.

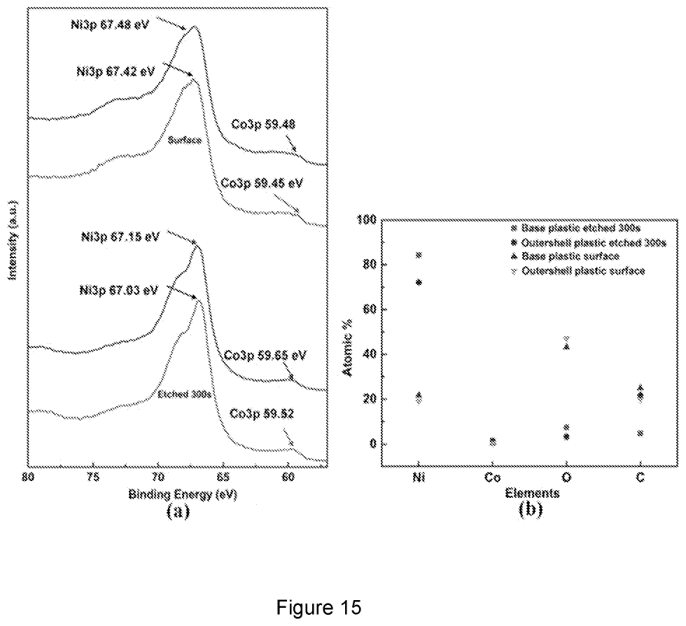

The composition and atomic concentration of elements in the nickel alloy were drawn from the simple surface analysis and etching for 300 sec by XPS measurement (FIG. 15). It was found that nickel and cobalt peaks (Ni3p and Co3p) occur in the binding energy region 60 to 70 eV (FIG. 15 (a)). Atomic concentrations of nickel (FIG. 15 (b)) obtained through base and outershell plastic were >84% and >72% respectively for the etched sample. The atomic weight percentage of cobalt is found to be almost similar: 1.75% for base plastic and 1.52% for outershell plastic with the peak binding energies 59.52 eV and 59.65 eV respectively for the etched surface. Detection of O1s and C1s with binding energies of 530 eV and 284 eV respectively, could result from oxygen and carbon contamination of the surface when exposed to atmosphere.

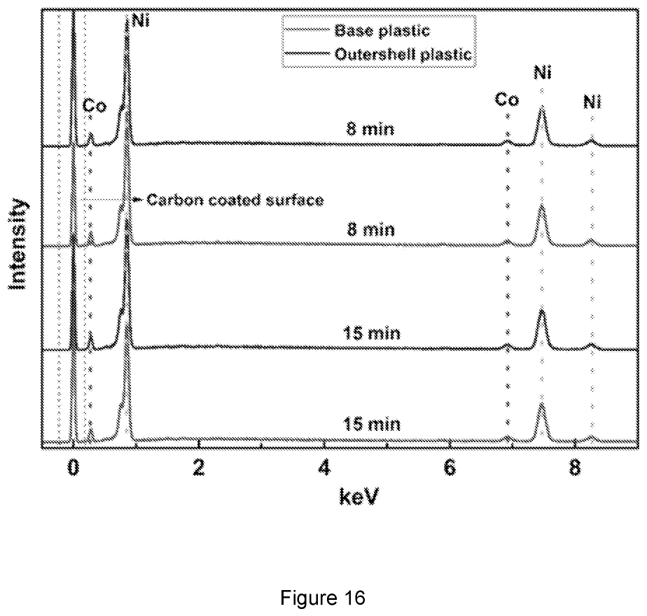

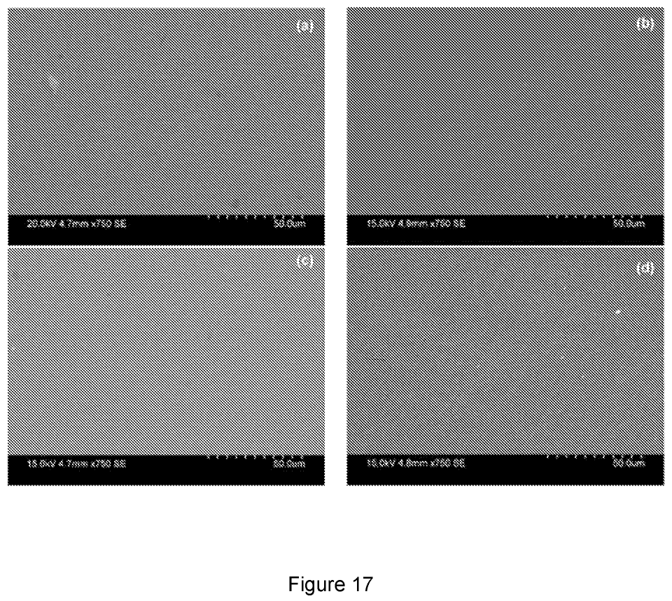

Formation of nickel alloy was also confirmed by EDS analysis (FIG. 16), which shows the dominant peaks of nickel (˜0.8 and 7.3 keV) in the metal alloy. A low intensity cobalt peak was observed at ˜0.4 and 6.9 keV in all metal alloy samples which confirms the formation of Ni alloyed with Co. The extra peak that is shown towards the extreme left of the EDS spectra belongs to carbon from the coating material. SEM images showing the morphologies of the alloy obtained using both plastics are in FIG. 17. Almost uniform and single-phase metal surface was observed which is also in agreement with the formation of nickel alloy.

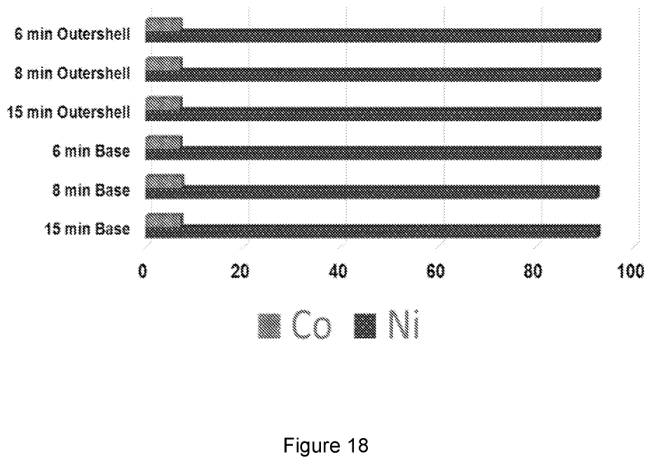

Furthermore, ICP-OES results are depicted in FIG. 18. Nickel appears to be >92% in the product alloys obtained by using both plastics at different reduction times such as 6 minutes, 8 minutes and 15 minutes. The percentage of cobalt varied slightly from 7.04% to 7.36% over time. Trace metals, namely zinc (˜0.006%) and manganese (˜0.25%) are also present in the final product sample. The weight % of Ni and Co confirms the purity of the alloy and complete reduction of nickel oxides by e-waste plastic. It is observed that the overall purity of the metal obtained (Ni and Co together) remains the same (about 99%) for reduction times of 6, 8 and 15 minutes using both plastics as reductants. This aligns closely with Ni200 alloy in terms of purity, thereby making it a possible feedstock for applications in corrosion prone environments, electronics and aerospace industries. Ni200 is used commercially as a pure wrought nickel with 99.6% of Ni and Co present together. Features, such as magnetostrictive properties, corrosion resistance, high thermal and electrical conductivities make Ni200 a widely used alloy for structural applications in corrosion prone environments, electronics and aerospace industries. The alloy produced could also be regarded as a Ni100 alloy with specification B50T517 (AIMTEK), having the same purity which is used extensively as a wide gap filler material for high temperature brazing applications.

The above results demonstrate the following:
(1) E-waste plastics may be used as a reductant to reduce NiO in the manufacture of value-added nickel alloys.
(2) The reduction was controlled by gases (H₂, CO, CO₂ and CH₄) released from the e-waste plastic.
(3) Hydrogen participates in the reduction for about 2 minutes, with the volume released significantly higher than CO and other gases in the case of both plastics.
(4) The nickel alloy recovered showed 99% purity as analysed by ICP-OES with ˜92% Ni and ˜7% Co.
(5) Different reduction times (6, 8 and 15 minutes) provided the same level of purity in the case of both plastics, thereby offering scope to use a mixture of computer monitor plastics for metal recovery.
(6) More than 90% reduction was achieved within 5 minutes.

### Example 2

### Materials and Methods

Electrode mass (a mixture of positive and negative electrodes) of waste Ni-MH batteries and waste toner powder were mixed to form 2 g pellets comprising either 50% toner powder and 50% electrode mass or 75% toner powder and 25% electrode mass. Pellets were prepared at room temperature using a hydraulic hot press operated at 30 bar for 5 min. Studies were performed at temperatures of either 1550° C. or 1450° C. under a constant argon atmosphere (1 litre/min) for 1 h in a horizontal high temperature tubular furnace (FIG. 2). Prior to this 1 h study, 15 min and 30 min experiments were performed; however, metallic droplet formation was not readily observed as a result of complete reduction, so reduction time was extended to 1 h.

Off-gases generated during the reduction experiment (1550° C., 25% electrode mass and 75% waste toner) were measured by an IR gas analyser connected to the horizontal tubular furnace with a gas filter (0.65 μm) placed at the gas outlet. Real time videos were also recorded to observe the reduction reaction and metal and slag formation/separation process.

### Results

### Characterisation of Electrodes of Waste Ni-MH Battery

Semi-quantitative XRF analysis as presented in Table 3 confirmed the presence of nickel as an oxide in the positive (65.64%) and negative (30.67%) electrodes of the waste Ni-MH battery. Oxide of cobalt was present at around 5% of the total chemical composition in both electrodes. The negative electrode also comprised cerium (6.29%) and lanthanum (14.10%). ICP-MS analysis (Table 3) showed that nickel content in positive and negative electrodes was 51.25% and 33.26% respectively. Additionally, Co was present at 6.38% in the negative electrode and 4.22% in the positive electrode. REEs, such as lanthanum (10.32 wt %) and cerium (10.76%), were present in the negative electrode.

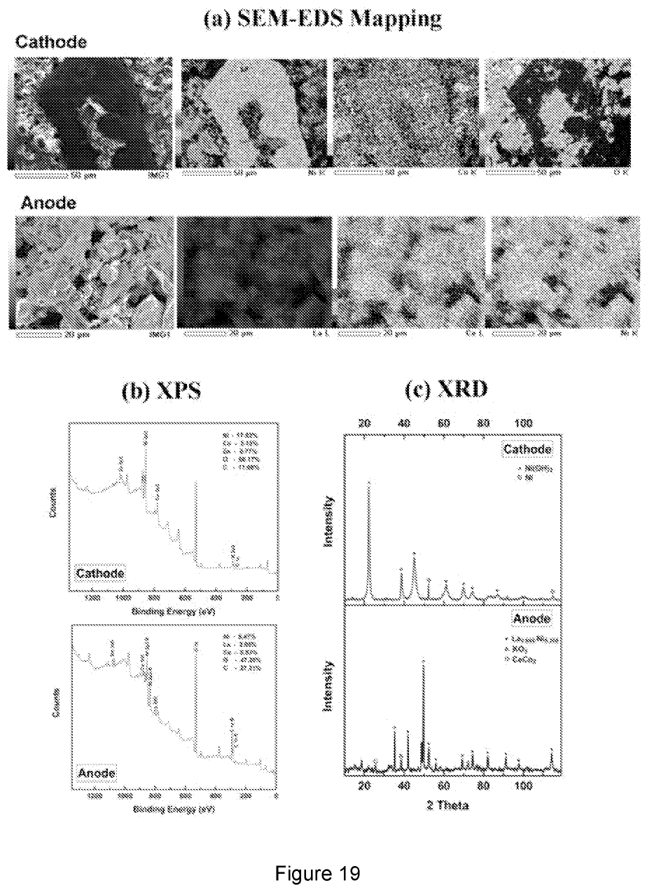

SEM-EDS mapping, surface analysis and XRD of positive and negative electrodes are shown in FIG. 19. The closely packed mass in the SEM image of the positive electrode indicates the presence of Ni and Co in the darker region surrounded by oxygen as observed in EDS. The negative electrode on the other hand shows the presence of rare earth elements such as lanthanum and cerium, which is consistent with the XRF and ICP-MS results, as well as the XPS and XRD spectra shown in FIGS. 19(b) and (c).

TABLE 3
XRF and ICP-OES results
showing the chemical composition by wt %

| Major | XRF | | ICP-MS | |
|---|---|---|---|---|
| elements | (wt. %) | | (wt. %) | |
| (oxides) | Cathode | Anode | Cathode | Anode |
| Ni | 65.64 | 30.67 | 51.25 | 33.26 |
| Co | 5.8 | 5.11 | 4.22 | 6.38 |
| Zn | 3.86 | — | 2.23 | — |
| La | — | 14.1 | — | 10.32 |
| Ce | — | 6.29 | | 10.76 |
| Nd | — | <3 | — | 3.45 |
| K | 4.53 | 21.7 | 4.26 | 15.8 |

Surface investigation of the positive electrode using XPS revealed the presence of Ni (2p3, peak binding energy 855.41 eV) and Co (2p3, peak binding energy 779.9 eV) having 17.53 atomic % and 3.13 atomic % respectively. Oxygen present in nickel hydroxide was observed in 1s state with 56.17 atomic % at 532.42 eV binding energy. Nickel was also detected in two sub-states in the negative electrode at 2p3 A (binding energy 855.49 eV) and 2p3 B (binding energy 861.17 eV). Noticeable peaks of REEs, namely lanthanum (2.05 atomic %, binding energy 838.42 eV) and cerium (0.53 atomic %, binding energy 887.82 eV) were also observed in the negative electrode. XRD spectra as shown in FIG. 19(c) highlight the wide distribution of the nickel hydroxide phase (ICDD:04-013-3641, ICDD:04-012-5845) in the positive electrode and metal alloys, such as lanthanum-nickel (Reference code:00-053-0618) and cerium-cobalt (ICDD:04-001-2710) present in the negative electrode.

### Characterisation of Waste Toner Powder

The waste toner powder basically comprised a polymer resin, including a good source of hydrocarbons that could essentially be converted into reducing gases (CO, CH₄, H₂) upon decomposition at high temperature. Upon decomposition, the waste toner powder left residue in the form of ash (33.37% by weight) which has a high iron oxide content (Fe₂O₃: 78.25%), constituting ˜33% by weight of the waste toner powder. Other oxides of manganese, magnesium and other metal oxides with silica were present at small concentrations in the ash as shown in the complete XRF results in Table 4.

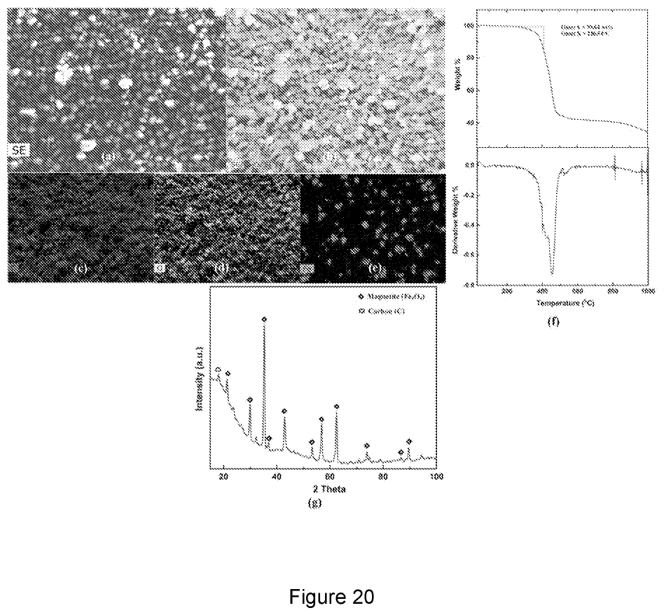

SEM-EDS, TGA with corresponding derivative, and XRD analysis of the waste toner are shown in FIG. 20. SEM (FIG. 20(a)) revealed the presence of spherical shapes in agglomerated form, having a diameter range of ˜5-10 μm. EDS mapping (FIG. 20(b)-(e)) confirmed that carbon is widely distributed in the matrix and also covers magnetite particles. Magnetite was also observed as independent agglomerates. FIG. 20(f) shows the decomposition behaviour of waste toner powder using thermogravimetric analysis (TGA). A constant heating rate (20° C./min) from room temperature to 1000° C. was carried out in a nitrogen environment. It was observed that the decomposition started early at 236° C. with the weight % decreasing from 100 to 30% within 450° C., thereby indicating poor thermal stability of the waste toner. However, the weight loss did not attain zero, indicating the presence of ash in the waste toner powder.

TABLE 4
XRF analysis results of waste toner powder

| | | Oxide | |
|---|---|---|---|
| Element | | wt. % | Toner ash |
| % N | 0.56 | SiO₂ | 6.22 |
| % C | 52.82 | TiO₂ | 1.31 |
| % H | 5.21 | Al₂O₃ | 0.37 |
| % S | 0.28 | Fe₂O₃ | 78.25 |
| | | Mn₃O₄ | 9.87 |
| | | MgO | 1.03 |
| | | CaO | 0.70 |
| | | Na₂O | 0.40 |
| | | K₂O | 0.02 |
| | | P₂O₅ | 0.02 |
| | | SO₃ | 0.47 |
| | | V₂O5 | 0.01 |
| | | Cr₂O₃ | 0.12 |
| | | ZrO₂ | <0.01 |
| | | SrO | 0.38 |
| | | CuO | 0.20 |
| | | ZnO | 0.20 |
| | | NiO | 0.08 |
| | | BaO | 0.05 |
| | | PbO | <0.01 |
| | | SnO₂ | 0.18 |
| | | L.O.I. | ND |
| | | TOTAL | 99.88 |

(i) L.O.I .= loss on ignition at 1,050° C.
(ii) ND = not determined
Volatiles (CHNS) analysed on Elementar
Vario Cube

Referring to the XRD spectra, magnetite was confirmed as the dominant crystalline phase (FIG. 20(g)). The characteristic peaks of the cubic magnetite were observed at 2θ values 30.1°, 35.4°, 43°, 56.9°, 62.3°, 74° with respective orientation planes (110), (021), (024), (125), (208), and (401). At 2θ=22.7° (120), hexagonal carbon having diminishing peak was also detected. The presence of magnetite and carbon, forming the core composition of waste toner powder, was validated with matching results obtained from XRF, SEM-EDS and XRD analyses.

### Formation of Fe—Ni Alloy and Reduction Mechanism

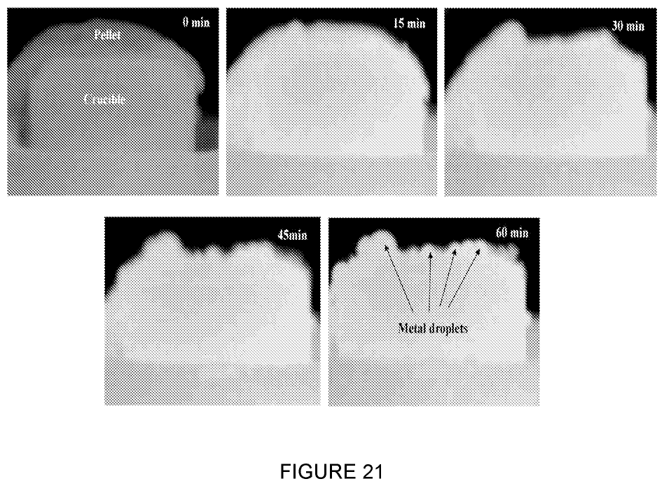

In situ video footage (snapshots presented in FIG. 21) showed the reduction reaction of the electrode mass with waste toner powder along with metal and slag formation. As the interaction of waste toner powder containing carbon with electrodes commenced, when the pellet was kept in the cold zone for 5 min at about 500° C., the shape of the pellet appeared to change before being moved to the hot zone at 1550° C. (0 min). The molten pellet as observed at 15 min and 30 min showed some separation of metal and slag phases as a result of reduction. Formation of metal droplets was visible at 45 min of the reduction experiment, while the slag containing REEs tend to flow off the crucible as a result of low viscosity. At 60 min, the formation of tiny metal droplets appeared to be complete, occurring separately from the slag.

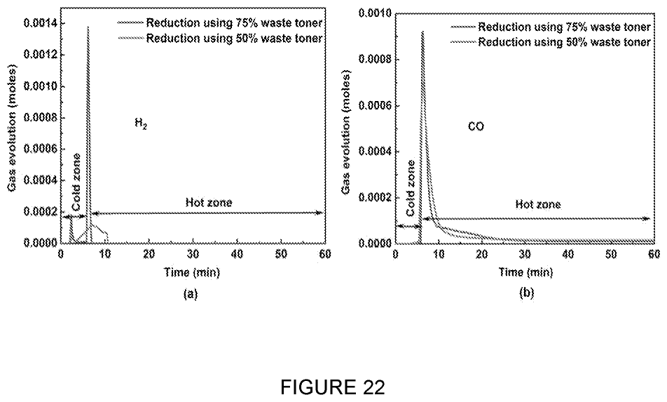

Referring to FIG. 22(a), the gas evolution spectrum showed an initial release of hydrogen (as a result of nickel hydroxide) in the low temperature zone, which explained the deformation in the pellet's shape. After 5 min, when the pellet entered the hot zone at 1550° C., the release of hydrogen was quick and dropped to zero after 2 min. The amount of hydrogen gas released was particularly high when 75% waste toner was used as compared to the amount released when 50% waste toner was used. The difference may be due to the higher resin (hydrocarbon) content in the 75% waste toner. CO release (FIG. 22(b)) in the high-temperature zone was higher when 75% waste toner was used as compared to when 50% waste toner was used. CO release peaked after about 7 min (for both 75% and 50% waste toner) when the hydrogen attains zero. CO declined slowly, finally attaining linearity at around 25 min. CO was still present in the system after 30 min, thereby progressing the reduction reaction until completion. This may have facilitated the formation of metal droplets when the reduction reaction reached 1 h.

The chemical reactions occurring during the course of the reduction begins with the thermal dissociation of polymers present in the waste toner powder to release reducing gases (CO, CH₄, and H₂) and conversion of hydroxide of nickel to its oxide form. Carbon in the waste toner is volatile, though solid in form, and hence tends to join the gas phase quickly when exposed to the furnace atmosphere.

CH₄→2C(s)+2H₂(g) Reaction 1

Ni(OH)₂(s)→NiO(s)+H₂O(g) Reaction 2

Oxides of iron are prone to reduce first as compared to nickel oxide due to the associated negative Gibbs free energy difference, and iron oxide is placed above nickel oxide in the Ellingham diagram. Hence, the reduction of iron oxide from Fe₃O₄ to FeO and finally metallic Fe occurs through several chemical reactions as set out below.

Fe₃O₄+CO(g)→FeO+CO₂(g) Reaction 3

FeO+C(s)→Fe(l)+CO(g) Reaction 4

FeO+CO(g)→Fe(l)+CO₂(g) Reaction 5

FeO+H₂(g)→Fe(l)+H₂O Reaction 6

It is expected that nickel oxide present in the electrode mass is reduced only by CO after the reduction of iron oxide to iron.

NiO(s)+CO(g)→Ni(l/s)+CO₂(g) Reaction 7

Other chemical reactions that are expected to occur are as follows:

CO₂(g)+C(s)→2CO(g) Reaction 8

CO₂(g)+H₂(g)→CO(g)+H₂O Reaction 9

As per iron-nickel phase diagram, at 1550° C. were in the liquid phase. During solidification iron nickel alloy in the γFeNi phase formed which was confirmed via XRD results.

### Characterisation of the Fe—Ni Alloy

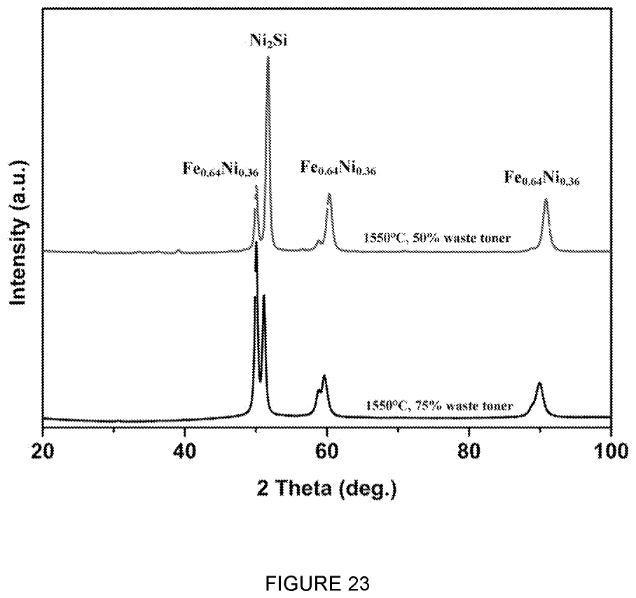

XRD peaks of the Ni—Fe alloy in the metal phase are shown in FIG. 23 with minor contamination observed in the form of silica, occurring as nickel-silicon alloy. The alloy formed between nickel and iron is cubic with lattice parameter 3.59 (ICDD: 04-002-1863) (same as that of fcc austenitic phase γ(Fe,Ni)) present in orientation planes (111), (200), and (220) with 2θ values ˜51°, ˜59° and ˜90°. The Ni—Si alloy impurity occurred in (121) plane with a 2θ value ˜53° (ICDD: 04-006-9132) having an orthorhombic crystal system. Metal droplets were not obvious when the temperature was reduced from 1550° C. to 1450° C. The Ni—Fe alloy peak was prominent when 75% waste toner was used. Gas evolution, both H₂ and CO, was higher when 75% waste toner was used. 1550° C. and 75% waste toner powder was therefore chosen for the formation of Ni—Fe alloys without any REEs, while enriching the slag with an oxide mixture of REEs.

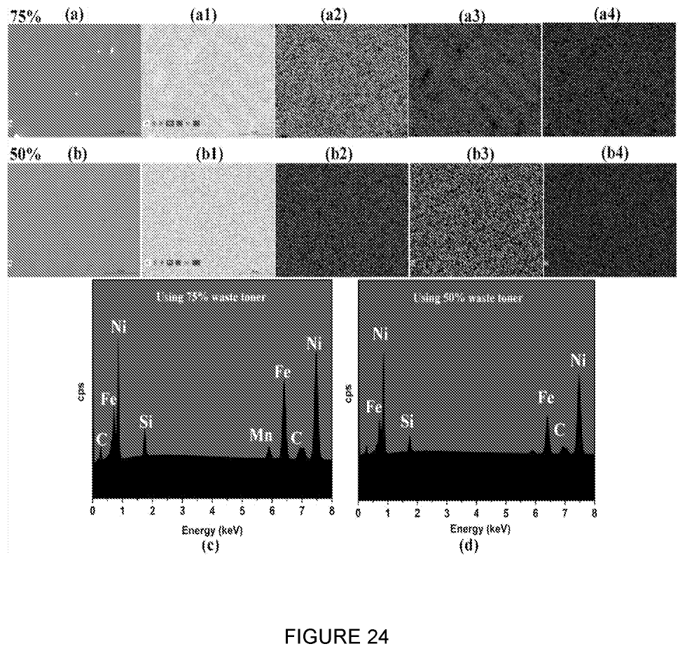

FIG. 24 depicts the SEM-EDS mapping and spectrum for the metal alloy obtained at 1550° C. using 75% and 50% waste toner powder. The surface morphology of the Fe—Ni alloy obtained using 75% waste toner (FIG. 24(a) was uniform with a single phase distribution while the EDS spectrum (FIG. 24(c)) showed the presence of Fe and Ni along with minor impurities (Mn and Si). The morphology of the product obtained using 50% waste toner differed, with fine inclusions spread throughout the surface as shown in FIG. 24(b). EDS mapping of the products obtained using 75% waste toner (FIG. 24(a1)-(a4)) and 50% waste toner (FIG. 24(b1)-(b4)) showed the presence of metal phases (Fe and Ni) along with traces of silicon (in agreement with the XRD spectrum of the metal alloy shown in FIG. 23) and carbon.

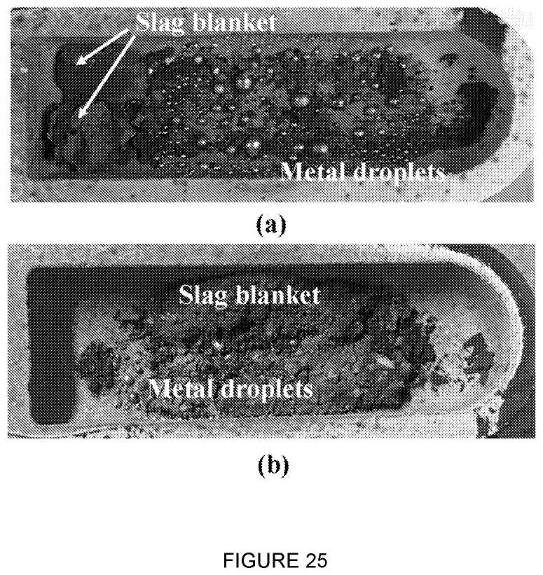

Metal droplets obtained by reducing Ni-MH electrodes with 75% waste toner or 50% waste toner at 1550° C. for 1 h are shown in the FIGS. 25(a) and (b) along with the initial slag blanket covering the metal droplets. The composition of the nickel alloys obtained under each condition as determined by a handheld laser induced breakdown spectrometer KT-100S (LIBS) is illustrated in Table 5. Ni content was >75% and Fe content was 14.9% in the alloy obtained using 75% waste toner. In contrast, Ni content was 57 wt % and Fe content was 32 wt % in the alloy obtained using 50% toner powder. The low Fe content in the alloy product despite adding 75% waste toner may be due to excess Fe₃O₄ which posed as a reduction barrier when iron oxide reduced from a higher to a lower oxidation number before forming metal. This, however, facilitated the reduction of NiO with availability of more reducing gases (CO and H₂). Si content was higher (4 wt %) in the alloy obtained using 50% waste toner as compared to the alloy obtained using 75% waste toner wherein Si content was 2.54 wt %. This accords with the XRD analysis shown in FIG. 23 which shows a prominent peak of Ni—Si in the sample obtained using 50% toner powder at 1550° C.

TABLE 5
LIBS analysis of alloy obtained using 75% and
50% waste toner powder at 1550° C.

| | 1550° C., | 1550° C., |
|---|---|---|
| | 75% waste | 50% waste |
| Metals | toner | toner |
| Ni wt % | 75.37 ± 4.06 | 57.09 ± 10.05 |
| Fe wt % | 14.93 ± 4.22 | 32.76 ± 11.9 |
| Co wt % | 2.74 ± 0.23 | . . . |
| Si wt % | 2.54 ± 0.39 | 4.06 ± 0.44 |
| Cr wt % | 1.96 ± 0.25 | 0.046 ± 0.017 |
| Mn wt % | 2.10 ± 0.13 | 5.57 ± 1.33 |
| Al wt % | 0.15 ± 0.04 | 0.035 ± 0.006 |

Even with some minor impurities, such as Si and Mn, the alloy obtained using 75% waste toner is positioned closely to the standards of the Ni96 alloy (Spec: PWA996) (AMTEK).

The alloy may be used as a semi-finished feedstock material at high temperatures and in areas prone to high-stress. Nickel already present in the metallic form as part of REEs alloy in the negative electrode joined the metal phase of the reduction reaction, thus improving the overall nickel content of the alloy.

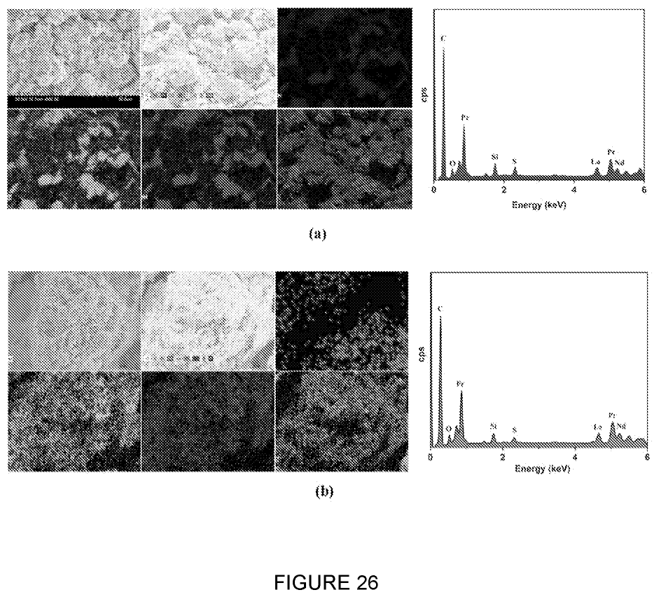

SEM and EDS mapping of the slag containing a mixture of REOs obtained at 1550° C. using 75% toner powder is shown in FIG. 26(a). The different rare earth oxides occurred together, having formed agglomerated crystals. The surface morphology was incoherent, which explains the nature of rare earth oxides. Additionally, some silicon was found in the oxide phase which could be attributed to the presence of 2.92% of SiO₂ in the waste toner powder. The EDS mapping (FIG. 26(b)) shows the concurrent presence of different REOs in the agglomerated form in the slag obtained using 50% waste toner powder. In both cases, the presence of different REOs was detected. The EDS spectra for the rare earth oxides are also shown next to the EDS mapping and clearly highlight the presence of Pr, La and Nd in the oxide phase.

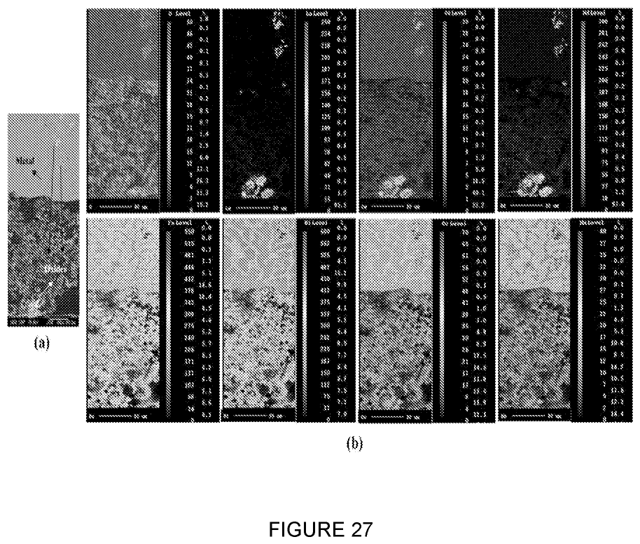

EPMA-WDS mapping analysis was also performed on the slag obtained using 75% waste toner with the help of WDS, JEOL JXA-8500F which shows the relative concentration of elements present in a specific area. Stage scan on the selected area was conducted which helped obtain the images (FIG. 27) at a beam energy (20 kV) and current 9.9×10−8 A with a dwell time 20 ms/pixel. Oxygen is seen along with REEs (La, Ce, Nd), thus confirming their presence in the slag as a mixture of REOs. However, there is also some Fe, Ni seen in the slag which could be a result of tiny metal droplets present.

These results demonstrate the following:
(1) The reduction of oxides of iron and nickel is gas controlled with CO playing the major role as a reductant and an initial contribution from H₂ gas.
(2) Fe—Ni alloy obtained at 1550° C. using 75% waste toner and 25% waste Ni-MH battery electrodes contained >75% Ni and >14% Fe.
(3) Waste toner powder influenced FeNi alloy formation by diffusing Ni into metallic iron.

Although the invention has been described with reference to specific embodiments, it will be appreciated by those skilled in the art that the invention may be embodied in many other forms.

1. A method of producing a nickel-containing alloy, the method comprising heating a mixture comprising carbon, nickel and an additional metal, wherein the nickel is obtained from a battery.

2. The method of claim 1 wherein the carbon is obtained from a waste material.

3. A method of producing a nickel-containing alloy, the method comprising heating a mixture comprising carbon, nickel and an additional metal, wherein the carbon is obtained from a waste material.

4. The method of claim 2 wherein prior to heating, the nickel, the additional metal and the waste material are formed into one or more pellets.

5. The method of claim 2 wherein the mixture is free, or substantially free, of a carbon source other than the waste material.

6. The method of claim 2 wherein the waste material is waste plastic.

7.-10. (canceled)

11. The method of claim 6 wherein the waste plastic is e-waste plastic obtained from computer monitor base stands and/or computer monitor outershells.

12. The method of claim 2 wherein the carbon and the additional metal are obtained from the waste material.

13. The method of claim 2 wherein the waste material is waste toner.

14. (canceled)

15. The method of claim 1 wherein the heating is performed at a temperature of at least about 1000° C.

16.-17. (canceled)

18. The method of claim 1 wherein the heating is performed in an inert atmosphere.

19. (canceled)

20. The method of claim 1 wherein the nickel is obtained from waste batteries.

21.-22. (canceled)

23. The method of claim 1 wherein the additional metal is one or more of: cobalt, iron, potassium, zinc, lanthanum or cerium-containing compound.

24. The method of claim 1 wherein the additional metal is in the form of an oxide.

25. The method of claim 1 wherein the additional metal is cobalt oxide.

26. The method of claim 1 wherein the additional metal is obtained from waste batteries.

27. (canceled)

28. The method of claim 1 wherein the nickel-containing alloy is a Ni—Co alloy.

29. The method of claim 1 wherein the additional metal is iron.

30. The method of claim 29 wherein the iron is in the form of iron oxide.

31. The method of claim 29 wherein the nickel-containing alloy is a Ni—Fe alloy.

32.-41. (canceled)
